(19) United States
(12) Patent Application Publication
(10) Pub. No.: US 2013/0281610 A1
(43) Pub. Date: Oct. 24, 2013

(54) RUBBER COMPOSITION FOR TREAD AND PNEUMATIC TIRE USING THE SAME FOR TREAD

(71) Applicant: SUMITOMO RUBBER INDUSTRIES, LTD., Kobe-shi (JP)

(72) Inventor: Ryoji KOJIMA, Kobe-shi (JP)

(73) Assignee: SUMITOMO RUBBER INDUSTRIES, LTD., Kobe-shi (JP)

(21) Appl. No.: 13/792,582

(22) Filed: Mar. 11, 2013

(30) Foreign Application Priority Data
Apr. 24, 2012 (JP) 2012-098974
Jan. 23, 2013 (JP) 2013-010335

(51) Int. Cl. C08K 3/04

(52) U.S. Cl. CPC C08K 3/04
USPC 524/575; 524/575.5; 524/571

(57) ABSTRACT

It is an object of the present invention to provide a rubber composition for a tread which can improve both performance on ice and abrasion resistance and a studless winter tire having a tread formed by this rubber composition. The present invention provides a rubber composition for a tread comprising 0.1 to 7.0 parts by mass of nanodiamond based on 100 parts by mass of a rubber component comprising at least one selected from a group consisting of a natural rubber, an isoprene rubber, a styrene butadiene rubber and a butadiene rubber, and a pneumatic tire having a tread formed by this rubber composition.

### TECHNICAL FIELD

The present invention relates to a rubber composition for a tread and a pneumatic tire using the rubber composition for a tread.

### BACKGROUND ART

Traditionally, the use of a studded tire or installation of a chain on a tire has been carried out for running on snow and ice road surfaces. However, when it is used, the surface of the road is damaged by a metal pin of the studded tire or the chain wound on the tire and problems such as an airborne pollution caused by the resulting particulates flying in the air are generated. Therefore, in place of which, a studless winter tire has been proposed as a tire for running on snow and ice road surfaces.

Since normal tires have remarkably lowered friction coefficient and slide easily on snow and ice road surfaces in comparison with general road surfaces, arrangements on materials and designs have been carried out for a studless winter tire. For example, a development of a rubber composition compounding a diene rubber which is excellent in properties at low temperature, or an arrangement of increasing an edge component on the surface by changing concavity and convexity on the tire surface has been reported. However, it is still impossible to say that steering stability of a studless winter tire on ice is sufficient.

JP 2002-047378 discloses a studless winter tire having a cap tread comprising a rubber composition which comprises inorganic short fiber having road scratching effect. However, due to stimulation such as running or abrasion, short fiber is dropped and results in a problem that scratching effect is lost.

Further, in conventional studless winter tires, abrasion resistance tends to be lowered because of their too much pursuance of performance on ice. Therefore, a studless winter tire balancing braking performance on ice and abrasion resistance is required.

### DISCLOSURE OF INVENTION

It is an object of the present invention to provide a rubber composition for a tread which can improve both braking performance on ice and abrasion resistance, and to provide a studless winter tire having a tread formed by this rubber composition.

The present invention relates to a rubber composition for a tread comprising 0.1 to 7.0 parts by mass of nanodiamond based on 100 parts by mass of a rubber component comprising at least one selected from a group consisting of a natural rubber, an isoprene rubber, a styrene butadiene rubber and a butadiene rubber.

The present invention also relates to a studless winter tire having a tread formed by the above rubber composition for tread.

According to the present invention, by comprising a predetermined amount of nanodiamond in a predetermined rubber component, it is possible to provide a rubber composition for a tread which can improve both braking performance on ice and abrasion resistance, and to provide a studless winter tire having a tread formed by this rubber composition.

### BEST MODE FOR CARRYING OUT THE INVENTION

The rubber composition for a tread of the present invention comprises a rubber component and nanodiamond.

The rubber component comprises at least one diene rubber component selected from a group consisting of a natural rubber (NR), an isoprene rubber (IR), a butadiene rubber (BR) and a styrene butadiene rubber (SBR). Among them, it is preferable to comprise a NR and a BR since they are excellent in properties at low temperature and a rubber component consisting of a NR and a BR only is more preferable.

The NR is not limited especially and ones generally used in the tire industry can be used. Examples thereof include SIR20, RSS#3 and TSR20. Additionally, the IR can also be ones generally used in the tire industry.

When the NR and/or IR is comprised in the rubber component, the amount thereof is preferably not less than 10% by mass and more preferably not less than 20% by mass, in view of excellent kneading processability and extrusion processability of the rubber. On the other hand, the amount of the NR and/or IR is preferably not more than 80% by mass and more preferably not more than 70% by mass in view of excellent properties at low temperature.

Various BRs including a high cis-1,4-polybutadiene rubber (high cis BR), a butadiene rubber comprising 1,2-syndiotactic polybutadiene crystal (SPB-containing BR) and a modified butadiene rubber (modified BR) can be used as the BR.

The high cis BR is a butadiene rubber in which the content rate of cis-1,4 bond is not less than 90% by weight. Examples of such a high cis BR are BR 1220 manufactured by Zeon Corporation and BR130B and BR150B manufactured by Ube Industries, Ltd. By comprising a high cis BR, properties at low temperature and abrasion resistance can be improved.

An example of the SPB-containing BR is not the one in which 1,2-syndiotactic polybutadiene crystal is dispersed in the BR, but the one in which 1,2-syndiotactic polybutadiene crystal is chemically bonded with the BR and dispersed. Examples of such SPB-containing BRs include VCR-303, VCR-412 and VCR-617 manufactured by Ube Industries, Ltd.

An example of the modified BR is a modified BR obtained by performing a polymerization of 1,3-butadiene with a lithium initiator and then adding a tin compound, and further the terminals of the BR molecule are bonded with a tin-carbon bond. Examples of such modified BRs include BR1250H (tin modified) manufactured by Zeon Corporation and S-modified polymer (silica modified) manufactured by Sumitomo Chemical Co., Ltd.

Among these varieties of BRs, it is preferable to use a high cis BR in view of its excellent properties at low temperature and abrasion resistance.

When the above BR is comprised in the rubber component, the amount thereof is preferably not less than 20% by mass and more preferably not less than 30% by mass, in view of improvement of properties at low temperature and abrasion resistance. On the other hand, the amount of the above variety of BRs is preferably not more than 90% by mass and more preferably not more than 80% by mass, in view of prevention of deterioration of rubber processability

A variety of SBRs such as an emulsion polymerized styrene-butadiene rubber (E-SBR) obtained by emulsion polymerization, a solution polymerized styrene-butadiene rubber (S-SBR) obtained by solution polymerization and modified SBRs in which these SBRs are modified (modified E-SBR, modified S-SBR) can be used as the SBR. However, it is preferable not to comprise these SBRs, because properties at low temperature of the rubber compositions are drastically lowered.

In addition to the above described NR, IR, BR and SBR, the diene rubber component can also include for example, an acrylonitrile-butadiene rubber (NBR), a chloroprene rubber (CR), a styrene-isoprene-butadiene rubber (SIBR) and an ethylene-propylene-diene rubber (EPDM). Among them, one or more kinds can be selected to be used together with at least one selected from a group consisting of NR, IR, SBR and BR. However, it is preferable not to comprise these additional diene rubber components, because properties at low temperature of the rubber compositions are drastically lowered.

In addition to the above described diene rubber component, the rubber component can also include a rubber component other than diene rubber component and examples thereof are a butyl rubber (IIR), a halogenated butyl rubber (X-IIR), a halogenated product of a copolymer of isomonoolefin and p-alkylstyrene. However, it is preferable not to comprise these rubber components, because properties at low temperature of the rubber compositions are drastically lowered.

The nanodiamond is nano-size diamond having a diamond crystal structure. By comprising nanodiamond in the rubber composition for a tread, scratching effect toward the ice road surfaces appears and braking performance on ice can be improved. Further, by comprising nanodiamond, since reinforcing effect can be obtained without increasing hardness of the rubber composition, abrasion resistance can be also improved at the same time.

The average primary particle size of the nanodiamond is preferably 4.0 to 6.0 nm and more preferably 4.5 to 5.5 nm. It is difficult to produce nanodiamond having the average primary particle size of less than 4.0 nm and the cost thereof tends to become high. On the other hand, if the average primary particle size is more than 6.0 nm, there is a tendency that braking performance on ice and abrasion resistance are not improved enough. Here, the average primary particle size of nanodiamond in the present invention is an average primary particle size measured by Laser Diffraction and Scattering Method.

The amount of the nanodiamond is not less than 0.1 part by mass, preferably not less than 0.15 part by mass and more preferably not less than 0.2 part by mass based on 100 parts by mass of the diene rubber component. If the amount is less than 0.1 part by mass, there is a tendency that braking performance on ice and abrasion resistance are not improved enough. On the other hand, the amount of the nanodiamond is not more than 7.0 parts by mass, preferably not more than 6.5 parts by mass and more preferably not more than 6.0 parts by mass. If the amount is more than 7.0 parts by mass, there is a tendency that the increase of hardness becomes large and braking performance on ice deteriorates.

In addition to the diene rubber component and nanodiamond, the rubber composition of the present invention can suitably comprise compounding agents or additives usually used in tire industry such as a variety of fillers for reinforcement, a coupling agent, a variety of oils, a softener, wax, a variety of anti-aging agents, a stearic acid, a vulcanization agent such as sulfur and a variety of vulcanization accelerators as necessary.

The above variety of fillers for reinforcement can be optionally selected and used among those commonly used in a rubber composition for a tire and mainly, carbon black or silica is preferable.

Examples of carbon black include furnace black, acetylene black, thermal black, channel black and graphite. These carbon blacks may be used alone, or at least two kinds may be combined and used. Among them, furnace black is preferable since it can improve properties at low temperature and abrasion resistance in a balanced manner.

The nitrogen absorption specific surface area (N₂SA) of carbon black is preferably not less than 70 m²/g and more preferably not less than 90 m²/g since sufficient reinforcing property and abrasion resistance can be obtained. On the other hand, the N₂SA of carbon black is preferably not more than 300 m²/g and more preferably not more than 250 m²/g in view of its excellent dispersibility and low heat build-up. Here, the N₂SA can be measured in accordance with JIS K 6217-2, “Carbon Black for Rubber Industry—Fundamental Characteristics—Part 2: Determination of Specific Surface Area—Nitrogen Adsorption Methods—Single-point Procedures”.

When carbon black is comprised, the amount thereof is preferably not less than 5 parts by mass and more preferably not less than 10 parts by mass based on 100 parts by mass of the diene rubber component. If the amount is less than 5 parts by mass, sufficient reinforcing property tends not to be obtained. On the other hand, the amount of the carbon black is preferably not more than 200 parts by mass, more preferably not more than 150 parts by mass and further preferably not more than 60 parts by mass. If the amount is more than 200 parts by mass, there is a tendency that processability is deteriorated, heat build-up is apt to arise and abrasion resistance is lowered.

Since the rubber composition of the present invention can balance braking performance on ice and abrasion resistance, it is preferably used for a tread and in case where the tread has a two layered structure of a cap tread and a base tread, it can be used for a cap tread.

The pneumatic tire of the present invention can be produced by a usual method using the rubber composition for a tread of the present invention. Namely, the rubber composition for a tread of the present invention which compounds the above compounding agents and additives as necessary is processed by extruding in conformity with the shape of the tread in unvulcanized condition. Then the unvulcanized rubber composition for a tread of the present invention is molded by being laminated together with other members of a tire on a tire molding machine by a usual method to form an unvulcanized tire. The pneumatic tire of the present invention is obtained by heating and pressuring the unvulcanized tire in a vulcanizer.

Since the pneumatic tire of the present invention can balance braking performance on ice and abrasion resistance, it is preferably used as a studless winter tire.

### EXAMPLES

The present invention is specifically illustrated based on Examples, but the present invention is not limited only thereto.

Various chemicals used in Examples and Comparative Examples are collectively described below.

Natural rubber (NR): RSS#3

Butadiene rubber (BR): Nipol BR1220 (high cis BR, cis content: 96.5%) manufactured by ZEON Corporation

Carbon black: SEAST N220 (N₂SA: 114 m²/g) manufactured by Mitsubishi Chemical Corporation
Zinc oxide: Zinc oxide No. 1 manufactured by Mitsui Mining & Smelting Co., Ltd.
Stearic acid: stearic acid Tsubaki manufactured by NOF Corporation
Oil: PROCESS X-140 manufactured by Japan Energy Co., Ltd.
Nanodiamond mixture: Blend grade (content rate of nanodiamond: 30% by mass, average primary particle size of nanodiamond: 5 nm) manufactured by Carbodeon Ltd Oy.
Anti-aging agent: Antigen 6C (N-(1,3-dimethylbutyl)-N′-phenyl-p-phenylenediamine) manufactured by Sumitomo Chemical Co.
Wax: SUNNOC N manufactured by OUCHISHINKO CHEMICAL INDUSTRIAL CO., LTD.
Sulfur: Powder sulfur available from Karuizawa Sulfur Co., Ltd.
Vulcanization accelerator (1): NOCCELER CZ (N-cyclohexyl-2-benzothiazolylsulfenamide) manufactured by OUCHISHINKO CHEMICAL INDUSTRIAL CO., LTD.
Vulcanization accelerator (2): NOCCELER D (N,N′-Diphenylguanidine) available from OUCHISHINKO CHEMICAL INDUSTRIAL CO., LTD.

### Examples 1 to 8 and Comparative Examples 1 to 3

According to the formulation shown in Table 1 and 2, chemicals other than sulfur and a vulcanization accelerator were kneaded for 3 to 5 minutes with a sealed 1.7 L Banbury mixer until the chemicals reach 150° C. to obtain a kneaded article. Then, the sulfur and the vulcanization accelerator were added to the obtained kneaded article, followed by kneading at 70° C. for two minutes with an open roll to obtain an unvulcanized rubber composition. And further, the obtained unvulcanized rubber composition was press-vulcanized at 170° C. for 12 minutes to obtain test rubber compositions of Examples 1 to 8 and Comparative Examples 1 to 3.

Further, the unvulcanized rubber composition was molded by extrusion with an extruding machine provided with an extrusion outlet of a predetermined shape and was laminated with other members of a tire to form an unvulcanized tire, followed by press vulcanization at 170° C. for 12 minutes to produce test tires (size: 195/65R15, studless winter tire).

### <Hardness at Low Temperature>

Using each test rubber composition, the hardness of the vulcanized rubber composition at low temperature (−10° C.) was measured with a type A durometer in accordance with JIS K6253 “Testing Methods to Measure Hardness of Vulcanized Rubber and Thermoplastic Rubber”. The results are shown with indices according to the following formula, regarding the index of Comparative Example 1 as 100. The less the index is, the less the hardness is and the more excellent the properties at low temperature is. The experimental results are shown in Table 1 and 2.

(Hardness index at low temperature)=(Hardness at low temperature of each test rubber composition)/(Hardness at low temperature of Comparative Example 1)×100

### <Braking Performance on Ice>

Each test tire was mounted on a test car (Japanese-made FR car, displacement: 2000 cc) and at Hokkaido Nayoro test course (temperature: −6 to −1° C.), a distance (stoppage distance) from the place where the brake of the test car running at a speed of 30 km/h was locked to the place where the test car stopped was measured. The results are shown with indices according to the following formula, regarding the index of Comparative Example 1 as 100. The larger the index is, the more excellent the braking performance is and the more excellent the braking performance on ice is. The experimental results are shown in Table 1 and 2.

(Braking performance index on ice)=(Stoppage distance of Comparative Example 1)/(Stoppage distance of each test tire)×100

### <Abrasion Resistance>

Each test tire was mounted on a test car (domestically produced FR car, displacement: 2000 cc), followed by running on the asphalt road for 8000 km. The groove depth of the tire tread portion was measured and the running distance at which the groove depth of the tire tread portion decreased by 1 mm was calculated. The results are shown with indices according to the following formula, regarding the index of Comparative Example 1 as 100. The larger the index is, the more excellent the abrasion resistance is. The experimental results are shown in Table 1 and 2.

(Abrasion resistance index)=(Running distance of each test tire)/(Running distance of Comparative Example 1)×100

TABLE 1

| | Ex. | | | | Com. Ex. | | |
|---|---|---|---|---|---|---|---|
| | 1 | 2 | 3 | 4 | 1 | 2 | 3 |
| Compounding | | | | | | | |
| amount | | | | | | | |
| (part by mass) | | | | | | | |
| NR | 50 | 50 | 50 | 50 | 50 | 50 | 50 |
| BR | 50 | 50 | 50 | 50 | 50 | 50 | 50 |
| Carbon black | 50 | 50 | 50 | 50 | 50 | 50 | 50 |
| Oil | 15 | 15 | 15 | 15 | 15 | 15 | 15 |
| Nanodiamond | 0.5 | 5 | 10 | 20 | — | 0.1 | 30 |
| mixture (Pure | (0.15) | (1.5) | (3) | (6) | (—) | (0.03) | (9) |
| nanodiamond | | | | | | | |
| therein) | | | | | | | |
| Stearic acid | 2 | 2 | 2 | 2 | 2 | 2 | 2 |
| Zinc oxide | 3 | 3 | 3 | 3 | 3 | 3 | 3 |
| Anti-aging agent | 2 | 2 | 2 | 2 | 2 | 2 | 2 |
| Wax | 2 | 2 | 2 | 2 | 2 | 2 | 2 |
| Sulfur | 1.5 | 1.5 | 1.5 | 1.5 | 1.5 | 1.5 | 1.5 |
| Vulcanization | 1.5 | 1.5 | 1.5 | 1.5 | 1.5 | 1.5 | 1.5 |
| accelerator (1) | | | | | | | |
| Vulcanization | 1 | 1 | 1 | 1 | 1 | 1 | 1 |
| accelerator (2) | | | | | | | |
| Evaluation result | | | | | | | |
| Hardness index | 100 | 101 | 103 | 105 | 100 | 100 | 115 |
| at low temper- | | | | | | | |
| ature | | | | | | | |
| Braking | 105 | 110 | 110 | 105 | 100 | 100 | 90 |
| Performance | | | | | | | |
| index on ice | | | | | | | |
| Abrasion | 100 | 103 | 105 | 110 | 100 | 100 | 115 |
| resistance | | | | | | | |
| index | | | | | | | |

TABLE 2

| | Ex. | | | |
|---|---|---|---|---|
| | 5 | 6 | 7 | 8 |
| Compounding amount | | | | |
| (part by mass) | | | | |
| NR | 40 | 40 | 60 | 60 |
| BR | 60 | 60 | 40 | 40 |
| Carbon black | 50 | 50 | 50 | 50 |
| Oil | 15 | 15 | 15 | 15 |
| Nanodiamond mixture | 5 (1.5) | 10 (3) | 5 (1.5) | 10 (3) |
| (Pure nanodiamond therein) | | | | |
| Stearic acid | 2 | 2 | 2 | 2 |
| Zinc oxide | 3 | 3 | 3 | 3 |
| Anti-aging agent | 2 | 2 | 2 | 2 |
| Wax | 2 | 2 | 2 | 2 |
| Sulfur | 1.5 | 1.5 | 1.5 | 1.5 |
| Vulcanization accelerator (1) | 1.5 | 1.5 | 1.5 | 1.5 |
| Vulcanization accelerator (2) | 1 | 1 | 1 | 1 |
| Evaluation result | | | | |
| Hardness index | 101 | 103 | 101 | 103 |
| at low temperature | | | | |
| Braking Performance index | 115 | 115 | 105 | 105 |
| on ice | | | | |
| Abrasion resistance index | 105 | 107 | 101 | 103 |

From the results shown in Table 1 and 2, it can be seen that the rubber composition for a tread comprising a predetermined amount of nanodiamond in the diene rubber component, and the pneumatic tire formed by this rubber composition are excellent in braking performance on ice and abrasion resistance.

What is claimed is:

1. A rubber composition for a tread comprising 0.1 to 7.0 parts by mass of nanodiamond based on 100 parts by mass of a rubber component comprising at least one selected from a group consisting of a natural rubber, an isoprene rubber, a styrene butadiene rubber and a butadiene rubber.

2. A studless winter tire having a tread formed by the rubber composition for a tread of claim 1.
